(19) United States
(12) Patent Application Publication
(10) Pub. No.: US 2014/0116186 A1
(43) Pub. Date: May 1, 2014

(54) STEERING COLUMN ASSEMBLY WITH IMPROVED ATTACHMENT TO A VEHICLE STRUCTURE

(71) Applicant: Melvin L. Tinnin, Clio, MI (US)

(72) Inventor: Melvin L. Tinnin, Clio, MI (US)

(21) Appl. No.: 13/664,908

(22) Filed: Oct. 31, 2012

(51) Int. Cl. B62D 1/184

(52) U.S. Cl. 74/493

(57) ABSTRACT

A steering column assembly comprises a column jacket, a lock control shaft, a band clamp disposed about the column jacket, and a cam disposed about the lock control shaft. A band clamp is disposed about the column jacket and comprises a circumferential band joined to a clamp arm. The clamp arm extends in a radially outward direction from the column jacket and defines a first shoulder facing toward a radially inward direction and a controlled surface facing in a first direction away from both the lock control shaft and the shaft head. The cam defines a defines a first control surface for interacting with the controlled surface such that, as the lock control shaft is placed in tension, the first control surface causes a band clamp radius to decrease and the band clamp to bear against the upper column jacket.

### BACKGROUND OF THE INVENTION

The present invention relates to steering columns and more particularly to systems and methods for attaching and releasing a steering column assembly to a structure of a vehicle.

Market forces are inducing vehicle suppliers to seek ways of meeting the sometimes conflicting desires to incorporate new features into the areas surrounding the vehicle steering column while also providing more compact vehicles. As a result, demands for space surrounding the steering column have increased while the space available has decreased. In particular, it is becoming more and more common for the space above and below the column to be limited. These space-based constraints have posed challenges to designers seeking to meet requirements relating to structural attachment of the steering column to the vehicle, to safety and reliability, and also to convenience. In particular, consumer desires for the ability to adjust positioning of the steering column have not decreased to accommodate the above-described increasing demands for space.

Accordingly, it is desirable to have improved systems and methods for selectively fixing and releasing a steering column while also providing for safe and reliable structural attachment of the steering column within reduced spaces above and beneath the steering column. It is also desirable to have a system and method for selectively fixing and releasing a steering column wherein the clamping hardware is disposed primarily toward a side of the steering column (e.g., arranged substantially horizontally from a centerline of the steering column).

### SUMMARY OF THE INVENTION

In one exemplary embodiment of the invention, a steering column assembly comprises an upper column jacket, through which a steering control shaft is supported for rotation about a longitudinal column axis. The steering column assembly includes a lock control shaft that defines a lock control axis, and the lock control shaft has an in-board end that defines a shaft head. A band clamp is disposed about the upper column jacket and defines an internal band clamp radius. The band clamp comprises a circumferential band joined to a first clamp arm. A cam is disposed about the lock control shaft, and the cam defines a first control surface.

The first clamp arm extends in a radially outward direction from the upper column jacket and defines a first shoulder facing toward a radially inward direction and a first controlled surface facing in a first direction away from both the lock control shaft and the shaft head. The first clamp arm defines a cavity between the first shoulder and the upper column jacket. The shaft head is disposed in the cavity so as to bear against the first shoulder. The first control surface is disposed and configured for interacting with the first controlled surface such that, as the lock control shaft is placed in tension drawing the shaft head along the lock control axis, the first control surface causes the first clamp arm to move toward the lock control shaft, thereby causing a band clamp radius to decrease and causing the band clamp to bear against the upper column jacket.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a perspective view of an exemplary steering column assembly;

FIG. 2 shows a side view of an exemplary steering column assembly; and

FIG. 3 shows a perspective view of a portion of a steering column assembly, with segments of the steering column assembly cut away to show otherwise hidden aspects steering column assembly.

### DETAILED DESCRIPTION

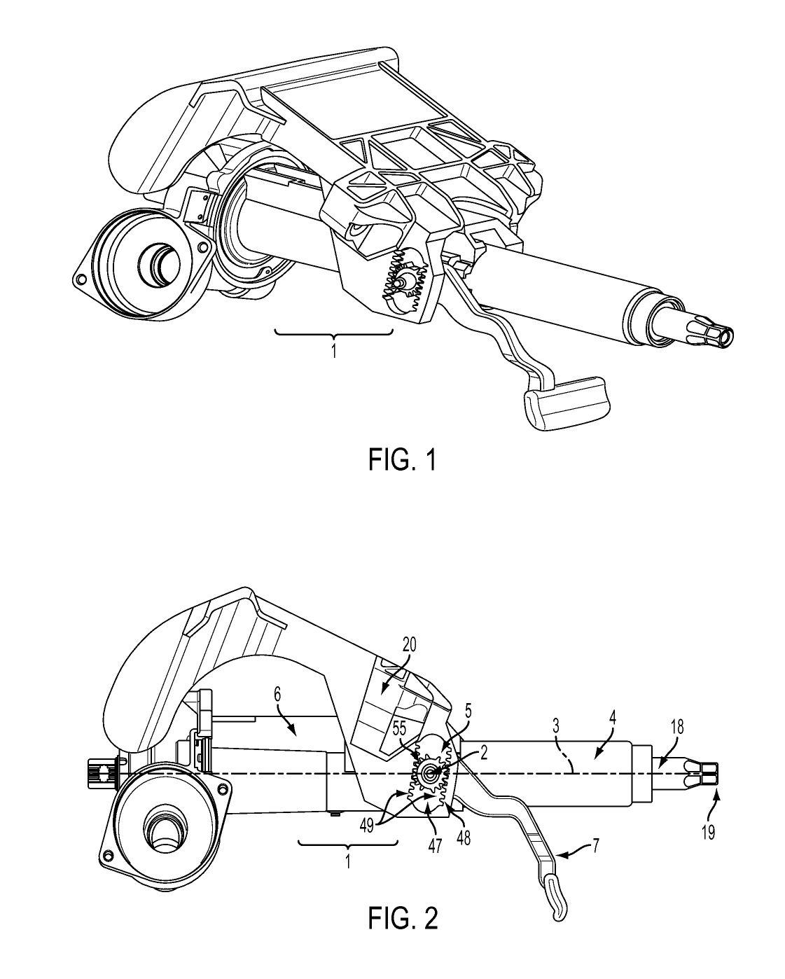

Referring now to the Figures, where the invention will be described with reference to specific embodiments, without limiting same, FIG. 1 and FIG. 2 show respective perspective and side views of a steering column assembly 1 in accordance with the invention. As shown in FIG. 1 and FIG. 2, the steering column assembly 1 comprises an upper column jacket 4, through which a steering control shaft 18 is supported for rotation about a longitudinal column axis 3. At an operator end (i.e., an upper end) 19, the steering control shaft 18 is configured for interacting with a steering wheel or other user control device (not shown) for facilitating user control of the vehicle. At an opposite end (i.e., a lower end) the steering control shaft 18 is coupled (e.g., via an intermediate shaft and/or via one or more gear mechanisms) to a steerable wheel of the vehicle. Thus, as an operator rotates a steering wheel of the vehicle, the steering control shaft 18 rotates about the longitudinal column axis 3, and control of the vehicle is provided.

In an exemplary embodiment, the upper column jacket 4 defines an internal cavity, within which the steering control shaft 18 is supported, and an inner column jacket 6 is also disposed within this internal cavity. The inner column jacket 6 may be in direct contact with the upper column jacket 4 or they may be separated by a bushing or bearing assembly to facilitate reliable telescoping movement relative to one another while also providing structural coupling the between the inner column jacket 6 and the upper column jacket 4. Thus, the inner column jacket 6 and the upper column jacket 4 are configured for telescoping movement along the longitudinal column axis 3.

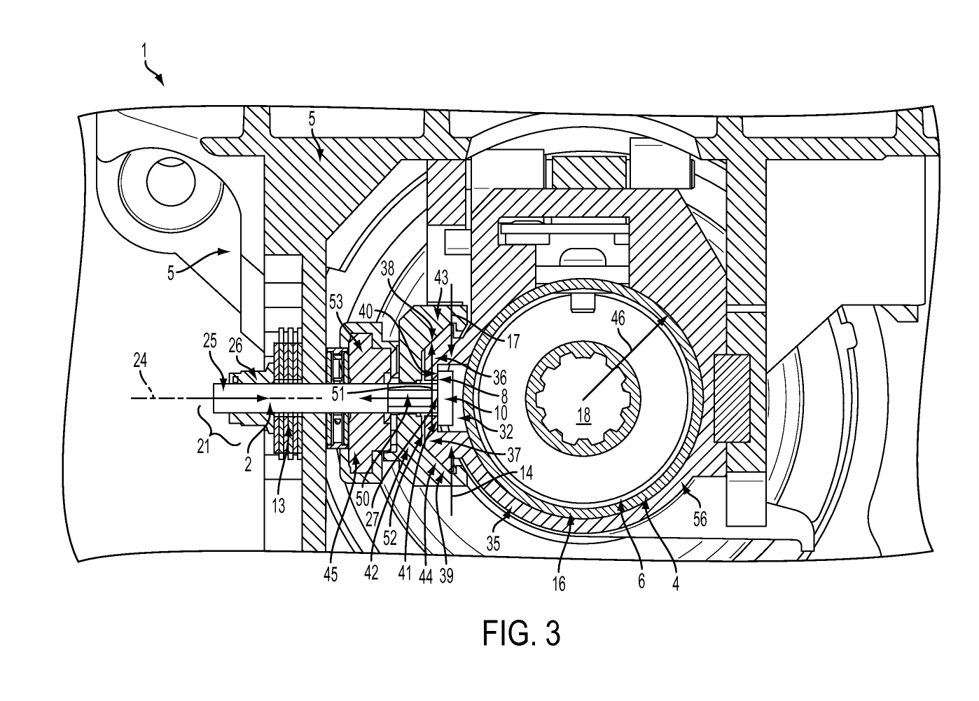

In an exemplary embodiment, the longitudinal column axis 3 is arranged in a vertically oriented plane that is parallel to a longitudinal axis of the vehicle. Adjustments to the position and orientation of the steering column assembly 1 may be facilitated in either or both of: (1) along the of the longitudinal column axis 3 (i.e., in a telescoping direction); and (2) in a vertical (i.e., raking) direction substantially perpendicular to the longitudinal column axis 3. To facilitate such adjustments to the position and orientation of the steering column assembly 1, as shown in FIG. 3, the steering column assembly 1 includes a position lock mechanism 21.

To enable a locked mode, wherein changes to the position of an operator end 19 of the steering control shaft 18 are substantially inhibited, the position lock mechanism 21 is configured to substantially fix a position of the upper column jacket 4 relative to a column mounting bracket 20, and thus the vehicle, when the position lock mechanism 21 occupies the locked mode. Similarly, to enable an adjustment mode, wherein changes to a position of the operator end 19 of the steering control shaft 18 are facilitated, the position lock mechanism 21 is configured to permit adjustments to the position of the upper column jacket 4 relative to the column mounting bracket 20, and thus the vehicle, when the position lock mechanism 21 occupies the adjustment mode.

Those skilled in the art will appreciate that a number of systems and methods are known for enabling the above-described locked mode and adjustment mode. For example, a locked mode may be activated by imposing a compressive load between adjacent friction lock members or by engaging sets of mating gears so as to inhibit relative movement. Similarly, an adjustment mode may be activated by releasing the compressive loads or disengaging the gear teeth. To provide operator selectivity between a locked mode and an adjustment mode, an adjustment lever arm 7 may be provided for releasing or applying the compressive load (or for engaging and disengaging the gear teeth) based on the position of the adjustment lever arm 7.

In an exemplary embodiment, the position lock mechanism 21 includes a rake lock actuator (not shown) and/or a telescope lock actuator (not shown). The adjustment lever arm 7 is coupled to the rake lock actuator and/or the telescope lock actuator such that the vehicle operator may select (e.g., by manipulating the adjustment lever arm 7) whether the position lock mechanism 21 is to occupy the locked mode or the adjustment mode. In embodiments that provide for telescoping adjustments of the steering column assembly 1, the position lock mechanism 21 is configured to cooperate so as to selectively enable such telescoping adjustments while in the adjustment mode and to prevent such telescoping adjustments while in the locked mode. Similarly, in embodiments that provide for raking adjustments of the steering column assembly 1, the position lock mechanism 21 is configured to selectively enable such raking adjustments while in the adjustment mode and to prevent such raking adjustments while in the locked mode.

During normal operation of the vehicle, the position lock mechanism 21 occupies a locked mode such that the upper column jacket 4 is fixed relative to the column mounting bracket 20. To enhance vehicle safety in situations wherein the vehicle encounters an excessive acceleration (e.g., such that a vehicle occupant may impact or press against the steering column assembly 1), the position lock mechanism 21 may be configured to release from the vehicle upon imposition of an impact force of sufficient magnitude. Alternatively, it may be the position lock mechanism 21 that is configured to selectively release the upper column jacket 4. In either of these configurations, however, the fixed relationship between the steering column assembly 1 and the vehicle is to be released upon the occurrence of the predetermined criteria. Thus, it is important for the attachment system and method to provide a reliable, yet releasable, structural attachment between the steering column and the vehicle.

FIG. 3 shows a cutaway view of an exemplary steering column assembly 1 viewed from the operator end 19 of the steering column assembly 1 and with the steering column assembly 1 being cut at a plane bisecting the position lock mechanism 21. As shown in FIG. 3, in an exemplary embodiment, the steering column assembly 1 comprises a band clamp 35 disposed about the upper column jacket 4. The band clamp 35 includes a circumferential band 56 and defines a band clamp radius 46. The circumferential band 56 is joined to a first clamp arm 36 and a second clamp arm 37, both clamp arms extending in a radially outward direction from the ends of the circumferential band 56, the ends being disposed proximate the upper column jacket 4. The first clamp arm 36 defines a cavity 32 between the first clamp arm 36 and the upper column jacket 4. The second clamp arm 37 also defines the cavity 32 between the second clamp arm 37 and the upper column jacket 4. The first clamp arm 36 includes a first shoulder 40 facing toward a radially inward direction from the first clamp arm 36, and the second clamp arm 37 includes a second shoulder 41 facing toward a radially inward direction from the second clamp arm 37.

An in-board end 27 of a lock control shaft 2 defines a shaft head 10, which is disposed in the cavity 32. The shaft head 10 bears against the first shoulder 40 and the second shoulder 41. The first clamp arm 36 defines a first controlled surface 38 that may be planar and that is disposed so as to face in a direction that is away from both the lock control shaft 2 and the shaft head 10. The second clamp arm 37 defines a second controlled surface 39 that may also be planar and that is also disposed so as to face in a direction that is away from both the lock control shaft 2 and the shaft head 10.

The lock control shaft 2 defines a lock control axis 24 along its length. A cam 42 is disposed about the lock control shaft 2. In an exemplary embodiment, the lock control shaft 2 has an eccentric region 50 (e.g., a spline, key, set screw, weld) for keying the lock control shaft 2 to the cam 42 such that the lock control shaft 2 and the cam 42 do not rotate relative to one another. In an exemplary embodiment, one or both of the lock control shaft 2 and the cam 42 are fixed such that they are both prevented from rotating about the lock control axis 24.

The cam 42 defines a first control surface 43 that is disposed for cooperation with the first controlled surface 38 of the first clamp arm 36. The first control surface 43 is thus disposed so as to face in a direction toward the first controlled surface 38 (i.e., parallel to the first controlled surface 38, in a direction that is toward both the lock control shaft 2 and the shaft head 10). A first contact distance 51, from the lock control axis 24, is defined by the location where the first controlled surface 38 contacts the first control surface 43. The first control surface 43 is configured for interacting with the first controlled surface 38 such that, as the shaft head 10 is drawn along the lock control axis 24, the shaft head 10 bears against the first shoulder 40, thereby causing: (1) the first clamp arm 36 to move relative to the cam 42; (2) the first controlled surface 38 to move along the first control surface 43; (3) the first contact distance 51 to decrease as the first clamp arm 36 moves in a radially inward direction toward the lock control shaft 2; and (4) the band clamp radius 46 to decrease. In an exemplary embodiment, the first control surface 43 and the first controlled surface 38 are configured as flat, planar surfaces. As a result, movement of the lock control shaft 2 so as to cause the shaft head 10 to bears against the first shoulder 40 may cause the band clamp 35 to bear against the upper column jacket 4.

The cam 42 also defines a second control surface 44 that is disposed for cooperation with the second controlled surface 39 of the second clamp arm 37. The second control surface 44 is thus disposed so as to face in a direction toward the second controlled surface 39 (i.e., parallel to the second controlled surface 39, in a direction that is toward both the lock control shaft 2 and the shaft head 10). A second contact distance 52, from the lock control axis 24, is defined by the location where the second controlled surface 39 contacts the second control surface 44. The second control surface 44 is configured for interacting with the second controlled surface 39 such that, as the shaft head 10 is drawn along the lock control axis 24, the shaft head 10 bears against the second shoulder 41, thereby causing: (1) the second clamp arm 37 to move relative to the cam 42; (2) the second controlled surface 39 to move along the second control surface 44; (3) the second contact distance 52 to decrease as the second clamp arm 37 moves in a radially inward direction toward the lock control shaft 2; and (4) the band clamp radius 46 to decrease. In an exemplary embodiment, the second control surface 44 and the second controlled surface 39 are configured as flat, planar surfaces. As a result, movement of the lock control shaft 2 so as to cause the shaft head 10 to bears against the second shoulder 41 may cause the band clamp 35 to bear against the upper column jacket 4.

In an exemplary embodiment, the position lock mechanism 21 is disposed along a side of the upper column jacket 4 that is disposed along a substantially horizontal direction from the longitudinal column axis 3. The lock control shaft 2 defines a lock control axis 24 along its length, and, in an exemplary embodiment, the lock control axis 24 is disposed generally horizontally and passes through, or nearly through, the longitudinal column axis 3. In an exemplary embodiment, the lock control shaft 2 is arranged so that the lock control axis 24 is directed substantially toward the longitudinal column axis 3. In an exemplary embodiment, the lock control shaft 2 is oriented substantially perpendicular to the upper column jacket 4.

As shown in FIG. 3, in an exemplary embodiment, the position lock mechanism 21 includes a position lock bracket 5 that is disposed about or adjacent to the generally cylindrical upper column jacket 4 and is configured for cooperating with mating lock plates 13. The position lock bracket 5, in cooperation with the lock plates 13, facilitates selectively enabling (i.e., in an adjustment mode) adjustments to the position of the upper column jacket 4, and thus the operator end 19 of the steering control shaft 18, within a range of adjustment provided by a lock bracket slot 47 (FIG. 2), which is defined in the position lock bracket 5.

In an exemplary embodiment, the lock control shaft 2 is disposed perpendicular to the position lock bracket 5 and the lock bracket slot 47, and is positioned within (i.e., as passing through) the lock bracket slot 47, such that, as a position of the upper column jacket 4 is adjusted, the lock control shaft 2, which is coupled for movement with the upper column jacket 4, traverses a range of motion within the lock bracket slot 47. In an exemplary embodiment, the lock bracket slot 47 defines a plurality of bracket teeth 48 disposed along edges 49 of the lock bracket slot 47. To facilitate structural attachment to the vehicle (i.e., in a locked mode), the position lock bracket 5 is fixed to the column mounting bracket 20, which is fixed to the vehicle.

In an exemplary embodiment, the position lock mechanism 21 comprises one or more lock plates 13 disposed about the lock control shaft 2 adjacent to the position lock bracket 5 such that a compressive load imposed between the one or more lock plates 13 and the position lock bracket 5 causes friction between the one or more lock plates 13 and the position lock bracket 5, thereby resisting translation of the one or more lock plates 13, and thus the lock control shaft 2, relative to the position lock bracket 5.

In an exemplary embodiment, the lock bracket slot 47 includes the plurality of bracket teeth 48 that mesh with plate teeth 55 of the lock plates 13 such that lock plates 13 must rotate if the lock control shaft 2 translates and such that the lock control shaft 2 cannot translate if the lock plates 13 do not rotate. The lock plates 13 are counter-rotating such that, translation of the lock control shaft 2 in a first direction causes adjacent lock plates 13 to rotate in opposite directions. When a compressive load is imposed between adjacent lock plates 13, the lock plates 13 are inhibited from rotating relative to one another.

In an exemplary embodiment, the lock control shaft 2 passes through the adjustment lever arm 7, the one or more lock plates 13, and the lock bracket slot 47 of the position lock bracket 5, as well as the cam 42, and a cam follower 45. A retainer 26 is disposed at an outboard end 25 of the lock control shaft 2 and may comprise a head fixed to the lock control shaft 2 or, alternatively, a threaded lock nut whose position on the lock control shaft 2 may be adjusted as it is threaded onto mating threads of the lock control shaft 2. At the in-board end 27 of the lock control shaft 2, the shaft head 10 cooperates with the lock control shaft 2 such that a compressive force (i.e., compressive load) may be exerted between the one or more lock plates 13 and the position lock bracket 5 as the lock control shaft 2 is placed in tension between the retainer 26 and the shaft head 10. As a result of the imposition of these forces, the one or more lock plates 13 may resist relative movement of the lock control shaft 2 relative to the position lock bracket 5. At the same time, the shaft head 10, which is disposed within the cavity 32, fixes the position of the lock control shaft 2 relative to the upper column jacket 4.

In an exemplary embodiment, the cam follower 45 is configured for interacting with the lock control shaft 2 and the cam 42 such that as the cam follower 45 rotates about the lock control axis 24 (e.g., in response to actuation of the adjustment lever arm 7) in a locking direction, an axial lobe 53 that is disposed on the cam follower 45 causes the lock control shaft 2 to be translated such that the shaft head 10 is drawn along the lock control axis 24 and the lock control shaft 2 is placed in tension, (e.g., by bearing against the position lock bracket 5 and the cam 42) and activates a position lock system configured for resisting translation of the lock control shaft 2 in a direction substantially orthogonal to the lock control shaft 2. In an exemplary embodiment, the cam follower 45 may be configured for imposing a compressive load between two or more lock plates 13 and/or between one or more lock plates 13 and the position lock bracket 5.

Accordingly, the lock plates 13, in cooperation with the position lock bracket 5 and the upper column jacket 4, provides a mechanism for selectively enabling or preventing adjustments to the position of the operator end 19 of the steering control shaft 18 in at least the direction associated with interaction of the one or more lock plates 13 and the position lock bracket 5. It should be noted, however, that the one or more lock plates 13 and the position lock bracket 5 may be configured to provide adjustment of the position of the steering column assembly 1 along one axis or two axes. More specifically, the one or more lock plates 13 and the position lock bracket 5 may be configured to provide adjustment/locking along only the raking direction, along only the telescoping direction, or along both telescoping and raking directions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly comprising:
an upper column jacket, through which a steering control shaft is supported for rotation about a longitudinal column axis;
a lock control shaft that defines a lock control axis, the lock control shaft having an in-board end that defines a shaft head;
a band clamp disposed about the upper column jacket and defining an internal band clamp radius, the band clamp comprising a circumferential band joined to a first clamp arm; and
a cam disposed about the lock control shaft, the cam defining a first control surface;
the first clamp arm extending in a radially outward direction from the upper column jacket and defining a first shoulder facing toward a radially inward direction and a first controlled surface facing in a first direction away from both the lock control shaft and the shaft head;
the first clamp arm defining a cavity between the first shoulder and the upper column jacket, the shaft head being disposed in the cavity so as to bear against the first shoulder;
the first control surface being disposed and configured for interacting with the first controlled surface such that, as the lock control shaft is placed in tension drawing the shaft head along the lock control axis, the first control surface causes the first clamp arm to move toward the lock control shaft, thereby causing a band clamp radius to decrease and causing the band clamp to bear against the upper column jacket.

2. A steering column assembly as described in claim 1, wherein:
the circumferential band is joined to a second clamp arm;
the cam defines a second control surface;
the second clamp arm extends in a radially outward direction from the upper column jacket and defines a second shoulder facing toward a radially inward direction and a second controlled surface facing in a second direction away from both the lock control shaft and the shaft head;
the second clamp arm defines a cavity between the second shoulder and the upper column jacket, the shaft head being disposed in the cavity so as to bear against the second shoulder; and
the second control surface being disposed and configured for interacting with the second controlled surface such that, as the lock control shaft is placed in tension drawing the shaft head along the lock control axis, the second control surface causes the second clamp arm to move toward the lock control shaft,
thereby causing the band clamp radius to decrease causing the band clamp to bear against the upper column jacket.

3. A steering column assembly as described in claim 1, wherein the first control surface is directed toward both the lock control shaft and the shaft head.

4. A steering column assembly as described in claim 2, wherein the second control surface is directed toward both the lock control shaft and the shaft head.

5. A steering column assembly as described in claim 1, wherein the first control surface is configured such that as the shaft head is drawn along the lock control axis, the shaft head bears against the first shoulder, thereby causing the first clamp arm to move along the lock control axis relative to the cam, thereby causing the first controlled surface to move along the first control surface, thereby causing the first clamp arm to move in a radially inward direction toward the lock control shaft.

6. A steering column assembly as described in claim 2, wherein the second control surface is configured such that as the shaft head is drawn along the lock control axis, the shaft head bears against the second shoulder, thereby causing the second clamp arm to move along the lock control axis relative to the cam, thereby causing the second controlled surface to move along the second control surface, thereby causing the second clamp arm to move in a radially inward direction toward the lock control shaft.

7. A steering column assembly as described in claim 1, further comprising a cam follower that is configured for interacting with the cam and the lock control shaft such that, as the cam follower rotates in a locking direction, an axial lobe that is disposed on the cam follower imposes a tension in the lock control shaft and thereby activates a position lock system configured for resisting translation of the lock control shaft in a direction substantially orthogonal to the lock control shaft.

8. A steering column assembly as described in claim 7, wherein the position lock system comprises one or more lock plates disposed about the lock control shaft adjacent to a position lock bracket, the one or more lock plates and the position lock bracket being configured such that a compressive load imposed between the one or more lock plates and the position lock bracket causes friction between the one or more lock plates and the position lock bracket to resist translation of the one or more lock plates, and thus the lock control shaft, relative to the position lock bracket.

9. A steering column assembly as described in claim 8, wherein the cam follower is configured for imposing a compressive load between the one or more lock plates and the position lock bracket.

10. A steering column assembly as described in claim 7, wherein:
the position lock system comprises one or more lock plates disposed about the lock control shaft and having plate teeth disposed about each of the one or more lock plates; and
a position lock bracket includes a plurality of bracket teeth disposed for interaction with the plate teeth such that as the lock control shaft translates, the one or more lock plates rotate relative to the position lock bracket, and such that, when the one or more lock plates are inhibited from rotating, translation of the lock control shaft in a direction substantially orthogonal to the lock control shaft is inhibited.

11. A steering column assembly as described in claim 10, wherein:
two or more lock plates are disposed within a lock bracket slot defined in the position lock bracket;
the plurality of bracket teeth are disposed on opposing sides of the lock bracket slot such that translation of the lock control shaft causes at least one of the two or more lock plates to rotate in a first direction while causing at least one of the two or more lock plates to rotate in a second direction;
thereby resisting translation of the lock control shaft when a compressive load is applied between the two or more lock plates.

12. A steering column assembly as described in claim 1, further comprising an inner column jacket disposed within the upper column jacket.

13. A steering column assembly as described in claim 12, wherein the inner column jacket and the upper column jacket are configured for telescoping movement along the longitudinal column axis.

14. A steering column assembly as described in claim 1, wherein a position lock bracket is configured to be fixed to a vehicle.

15. A steering column assembly as described in claim 1, wherein the lock control shaft is disposed so that the lock control axis is substantially horizontal.

16. A steering column assembly as described in claim 1, wherein the lock control shaft is disposed so that the lock control axis is directed substantially toward the longitudinal column axis.

17. A steering column assembly as described in claim 7, wherein a position lock bracket defines a lock bracket slot along a raking direction, through which the lock control shaft is disposed.

18. A steering column assembly as described in claim 7, wherein a position lock bracket defines a lock bracket slot along a telescoping direction, through which the lock control shaft is disposed.

19. A steering column assembly as described in claim 1, further comprising an adjustment lever arm coupled to the lock control shaft for moving the lock control shaft from a locked mode to an adjustment mode.
